(19) United States
(12) Patent Application Publication
(10) Pub. No.: US 2009/0244623 A1
(43) Pub. Date: Oct. 1, 2009

(54) IMAGE FORMING APPARATUS

(76) Inventor: Takao Kurohata, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/413,356

(22) Filed: Mar. 27, 2009

(30) Foreign Application Priority Data
Apr. 1, 2008 (JP) JP2008-094789

(51) Int. Cl. G06K 15/00

(52) U.S. Cl. 358/1.16

(57) ABSTRACT

An image forming apparatus for outputting images in an output unit of multiple sets each including multiple pages with specified order, having: a storage section which stores page data including identification information; a reading-out section which reads out the page data according to the output unit; an image forming section which, based on the page data from the reading-out section, sequentially forms images on multiple recording sheets; a control section which executes a calculation processing that depends on the read out order of the page data, for each output unit, by using the identification information; memory sections which memorize results of the calculation processing for the output units of nth set and other than nth set; wherein the control section determines whether images are correctly formed on the recording sheets for the output unit of other than nth set, based on comparison of the results of calculation processing.

### CROSS REFERENCE TO RELATED APPLICATION

The present application is based on Japanese Patent Application No. 2008-094789 filed with Japanese Patent Office on Apr. 1, 2008, the entire content of which is hereby incorporated by reference.

### BACKGROUND OF THE INVENTION

1. Technical Field

The present invention relates to an image forming apparatus which outputs images in an output page unit of a plurality of sets, wherein the output page unit of one set is configured with a plurality of pages of specified order.

2. Description of Prior Art

Conventionally, an image forming apparatus is well known which forms images on a recording sheet and outputs the recording sheet on which the images are formed. The image forming apparatus includes, for example, a copying machine and a printer. In a case where the image forming apparatus is a copying machine, the image forming apparatus obtains image data by reading out images from original documents. While, in a case where the image forming apparatus is a printer, the image forming apparatus obtains image data from an external apparatus such as a personal computer.

As a way of utilizing the image forming apparatus, a case to be pointed out is that the image forming apparatus outputs an output page unit configured with a plurality of pages. In such case, a confirmation work to check whether images are correctly formed on recording sheets is important. For example, in the confirmation work, it is confirmed whether there is a missing page or a paging disorder.

In cases where an output page unit of a plurality of sets is outputted, to execute the confirmation work by visual observation is cumbersome. Therefore, it is preferable to automate the confirmation work.

In order to cope with this situation, a technique is disclosed (for example in JP No. 2007-189315A), which compares the total number of pixels constituting a plurality of pages included in an nth output page unit with the total number of pixels constituting a plurality of pages included in an n+1th or later output page unit (hereinafter referred as the first technique). To be specific, the image forming apparatus determines that in cases where the two total numbers of pixels are identical with each other, there is no page missing or paging disorder in n+1th or later output page units. Meanwhile, the image forming apparatus determines that in cases where the two total numbers of pixels are not identical, there is a page missing or a paging disorder in n+1th or later output page units.

Further, the other technology (hereinafter referred as the second technology) is proposed where an image of identification information to identify the recording sheet is formed on a recording sheet in addition to an image to be formed based on an image data (refer to for example JP No. 2005-186464A). Specifically, the image forming apparatus previously memorizes the identification information in a memory. While the image forming apparatus forms an image of the identification information on a recording sheet. Subsequently, the image forming apparatus compares identification information included in the image of identification information formed on the recording sheet with the identification information memorized in the memory. The image forming apparatus determines that in cases where the two pieces of identification information are identical, there is no page missing or paging disorder in an output page unit. Meanwhile, the image forming apparatus determines that in cases where the two pieces of identification information are not identical, there is a page missing or a paging disorder in the output page unit.

However, in the above-described first technique, since the image forming apparatus compares the number of total pixels, turnover of pages (or replaced pages) in an output page unit cannot be detected.

In the above described second technology, since the image of identification information needs to be formed on the recording sheet, the image other than the image based on the image data is formed on the recording sheet. Further, according to the second technique, the identification information needs to be managed for each page, which causes a heavy load of identification information management.

The present invention is achieved in order to solve the above-described problems, and an object of the present invention is to provide an image forming apparatus which enables to easily detect the missing page and turnover of pages.

To achieve at least one of the above-mentioned objects, an image forming apparatus reflecting one aspect of the present invention for outputting images in an output page unit of a plurality of sets, wherein the output page unit of one set is configured with a plurality of pages, each page having a specified order; the image forming apparatus including:

a storage section which stores page data corresponding to each of the plurality of pages, the page data including identification information corresponding to each of the plurality of pages;

a reading-out section which reads out the page data from the storage section according to the output page unit of the plurality of sets;

an image forming section which, based on the page data read out by the reading-out section, sequentially forms each of the images corresponding to each of the plurality of pages on a plurality of recording sheets;

a control section which executes a calculation processing that depends on the read out order of the page data, for each of the output page unit, by using the identification information included in the page data read out by the reading-out section;

a first memory section which memorizes a first result of the calculation processing executed for the output page unit of a nth set out of the output page unit of the plurality of sets; and

a second memory section which memorizes a second result of the calculation processing executed for the output page unit of other than the nth set out of the output page unit of the plurality of sets;

wherein the control section comprises a determination section which determines whether the images are correctly formed on the plurality of recording sheets for the output page unit of other than the nth set, based on a result of comparison of the first result of calculation processing memorized in the first memory section with the second result of calculation processing memorized in the second memory section.

The image forming apparatus reflecting the other aspect of the present invention further includes:

a compression section which compresses image data corresponding to each of the plurality of pages to obtain compressed image data; and

a providing section which provides the identification information on each of the plurality of pages, wherein the storage section stores the identification information and the compressed image data as the page data.

The image forming apparatus reflecting another aspect of the present invention further includes a notifying section which notifies a set number of the output page unit where an abnormality has occurred, in the case where the determination section has determined that the images are not correctly formed on the plurality of recording sheets.

### BRIEF DESCRIPTION OF THE DRAWINGS

These and other objects, advantages and features of the invention will become apparent from the following description thereof taken in conjunction with the accompanying drawings in which:

FIG. 1 illustrates a schematic diagram showing the configuration of image forming apparatus 100 relating to the first embodiment of the present invention;

FIG. 2 illustrates a schematic diagram showing the configuration of control unit relating to the first embodiment;

FIG. 3 illustrates a table showing the page data relating to the first embodiment;

FIG. 4 illustrates a drawing to explain the abnormality determination process relating to the first embodiment;

FIG. 5 illustrates a drawing to explain the abnormality determination process relating to the first embodiment;

FIG. 6 illustrates a flow diagram showing the operation of image forming apparatus 100 relating to the first embodiment;

FIG. 7 illustrates a flow diagram showing the operation of image forming apparatus 100 relating to the first embodiment;

FIG. 8 illustrates a flow diagram showing the operation of image forming apparatus 100 relating to the first embodiment; and

FIG. 9 illustrates a schematic diagram showing the structure of image forming apparatus 100 relating to the second embodiment.

### DETAILED DESCRIPTION OF THE PREFERRED EMBODIMENTS

Hereinafter, the image forming apparatus relating to embodiments of the present invention will be described referring to the drawings. In the description of the drawings the same or similar signs are adopted to the same or similar parts.

The drawings are schematic, and each dimension or ratio of the dimension in the drawings may be different from the actual case. Therefore, specific dimensions should be acknowledged referring to the following descriptions. Further, between the drawings there may be differences regarding relationship of dimensions or dimensional ratios.

### First Embodiment

### (Outline of the Image Forming Apparatus)

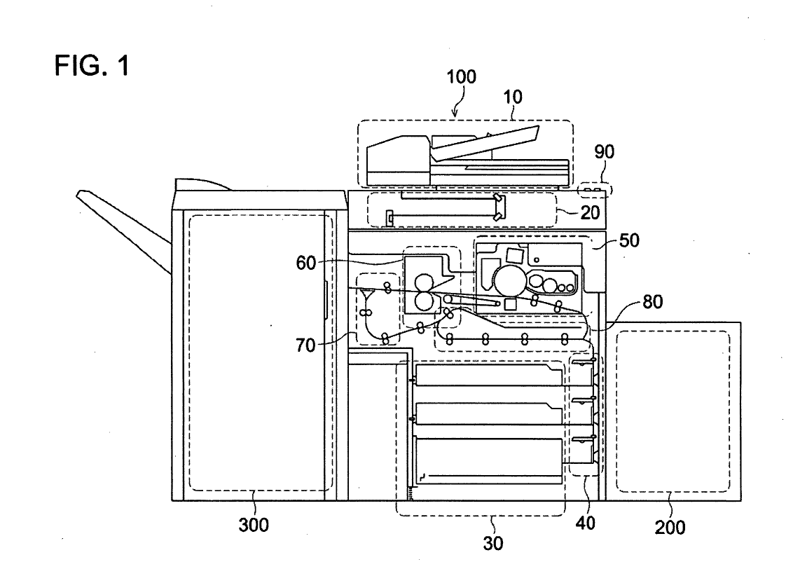

Referring to the drawings, the outline of the image forming apparatus relating to the first embodiment will be described below. FIG. 1 is a drawing showing the outline of image forming apparatus relating to the first embodiment. In FIG. 1, detailed structures of image forming apparatus are omitted.

As shown in FIG. 1, image forming apparatus 100 has automatic document feeding unit 10, image reading unit 20, paper tray unit 30, paper feeding unit 40, image forming unit 50, fixing unit 60, paper ejection unit 70, reversing unit 80, and operation unit 90. As shown in FIG. 1, image forming unit 100 is installed with paper supply apparatus 200 and post-processing apparatus 300.

In the first embodiment, a digital copier which forms an image on a paper by utilizing an electrophotographic process is shown as an example of image forming apparatus 100. However, the image forming method is not restricted to the electrophotographic process, but an inkjet system, a thermal transfer system, and a dot impact system are applicable.

In the first embodiment, image forming apparatus 100 has a function of outputting an output page unit of a plurality of sets, where an output page unit of a single set is configured with a plurality of pages. For example, the output page unit is such as a publication, an issue or a conference material.

Automatic document feeding unit 10 conveys an original document to be copied. In specific, automatic document feeding unit 10 includes an original document tray, original document separation section, original document conveyance section, original document ejection section, original document exit tray, and original document reversing section.

The original document tray is a tray for loading original documents. The original document separation section separates the multiple original documents loaded on the original document tray to each single sheet of original document to feed. The original document conveyance section includes a group of rollers that conveys the original document separated by the original document separation section to an original reading position. The original document ejection section ejects the original document conveyed by the original document conveyance section into the original document exit tray. The original document exit tray is a tray for taking on the ejected original document. The original document reversing section turns over the faces of the original document in a double face copying mode.

Image reading unit 20 reads out the image of the original document and creates analogue data as the image data. Specifically, image reading unit 20 includes a slit, a platen glass, a lamp, a mirror unit, imaging lens, and an image capturing element.

The slit is an area where light beams emitted from the lamp pass through. The light beams emitted through the slit expose the original document at the image reading position.

The platen glass is a table on which the original document is placed in cases where copying is performed without using automatic document feeding unit 10.

The lamp emits light beams exposing the original document. In the case of using automatic document feeding unit 10, the lamp exposes the original document through a slit. While, in the case of not using automatic document feeding unit 10, the lamp exposes the original document while moving along the lower surface of the platen glass. The mirror unit reflects the light beam reflected from the original document, and guides it toward an imaging lens. The imaging lens forms an optical image with light beams reflected from the mirror unit. Specifically, the imaging lens focuses the light beams reflected from the original document onto the image capturing element. The image capturing element is a photoelectric conversion element such as a CCD that reads the light beams focused by the imaging lens.

Paper tray unit 30 is a unit to accommodate recording sheets. Paper tray unit 30 includes a plurality of paper feed trays, a plurality of paper feed rollers, a plurality of separation rollers, a plurality of photosensors, and a manual feed tray.

Each paper feed tray accommodates a plurality of recording sheets. Each paper feed roller sends out the recording sheet accommodated in the paper feed tray toward the separation roller. Each separation roller separates the recording sheets sent from the paper feed roller one by one. Each photosensor PS detects whether the recording sheet reached to a group of rollers which being explained below. The manual feed tray is a tray on which a recording sheet is placed.

Paper feed unit 40 feeds the recording sheets into image forming unit 50. Paper feed unit 40 includes a plurality of roller groups, conveyance rollers, registration rollers, and pre-transfer rollers.

The plurality of roller groups convey the recording sheets accommodated in paper tray unit 30 or paper feed apparatus 200. Conveyance rollers convey the recording sheets conveyed by the plurality of roller groups toward the registration rollers. Further, the conveyance rollers convey the recording sheet conveyed from paper ejection unit 70 (which being explained below) toward the registration rollers. The registration rollers convey the recording sheet conveyed from the conveyance rollers to the pre-transfer rollers. Further, the registration rollers convey the recording sheet conveyed from the manual feeding tray to the pre-transfer rollers. On the timing when the recording sheet has arrived at the registration rollers, image forming unit 50 starts the image formation. The pre-transfer rollers convey the recording sheet conveyed from the registration rollers toward image forming unit 50.

Image forming unit 50 forms a toner image on the recording sheet fed from paper feed unit 40 based on digital data as the image data generated by image reading unit 20. Image forming unit 50 includes a photosensitive drum, a charging unit, a write-in processing unit, a developing unit, a transfer unit, a separation unit, a cleaning unit, and a conveyance belt.

The photosensitive drum has a surface on which a photoconductive layer is formed. On the surface of the photosensitive drum, as will be described below, an electrostatic latent image configured with electrostatic charges is formed. The charging unit uniformly charges the surface of the photosensitive drum.

The write-in processing unit (write-in processing section 480, which will be described below) forms the electrostatic latent image on the surface of the photosensitive drum based on the image data generated by image reading unit 20. Specifically the write-in processing unit has a laser device to emit a laser beam, and exposes the surface of the photosensitive drum by the laser beam.

The developing unit forms a toner image on the surface of the photosensitive drum by reversal development of the electrostatic latent image. The transfer unit has a transfer electrode to charge the recording sheet fed from paper feed unit 40. The transfer unit transfers the toner image formed on the surface of the photosensitive drum onto the recording sheet.

The separation unit separates the recording sheet, on which the toner image is formed, from the photosensitive drum. Specifically, the separation unit has a separation electrode to execute corona discharging, and the corona discharging, urges the separation of the recording sheet. The cleaning unit cleans the surface of the photosensitive drum. Specifically, the cleaning unit removes the toner remaining on the surface of the photosensitive drum. The conveyance belt conveys the separated recording sheet into fixing unit 60.

Fixing unit 60 fixes the toner image formed on the recording sheet by heat fixing onto the recording sheet. Fixing unit 60 has a heat roller, a pressure roller and a cleaning web.

The heat roller heats the recording sheet bearing the toner image. The heat roller conveys the recording sheet by nipping the recording sheet between the heat roller and the pressure roller. The cleaning web removes the toner attached to the pressure roller.

Paper ejection unit 70 ejects the recording sheet on which the toner image is fixed. Meanwhile, paper ejection unit 70 is a unit to reverse faces of the recording sheet in a double face copying mode. Paper ejection unit 70 has fixing ejection rollers, a switching section, paper ejection rollers, a paper exit tray, and conveyance rollers.

The fixing ejection rollers convey the recording sheet conveyed from fixing unit 60 toward the switching section. The switching section switches the recording sheet conveyed by the fixing ejection rollers whether to eject or not to eject. Specifically, the switching section switches the conveyance route of the recording sheet toward the ejection rollers in a single face copying mode. In a double face copying mode, in case that toner image formation on both faces of the sheet has completed, the switching section switches the conveyance rout toward the paper ejection rollers. Meanwhile, in a double face copying mode, in case that toner image formation on one face of the sheet has not completed, the switching section switches the conveyance rout toward reversing unit 80.

The paper ejection rollers eject the recording sheet on which toner image has been fixed toward post-processing apparatus 300. The conveyance rollers convey the recording sheet, on which the image on one face is not completed in the double face copying mode, toward reversing unit 80.

Reversing unit 80 turns over the faces of the recording sheet, on which the image on one face is not completed in the double face copying mode. Reversing unit 80 conveys the recording sheet conveyed from paper ejection unit 70 toward image forming unit 50. Namely, reversing unit 80 re-feeds the recording sheet to image forming unit 50.

Operation unit 90 is a user interface for operating image forming apparatus 100. Operation unit 90 is configured with a touch panel type liquid crystal panel, buttons and switches.

Paper supply apparatus 200 accommodates a larger amount of recording sheets than paper tray unit 30. Paper supply apparatus 200 is used in place of paper tray unit 30 in cases where the number of pages constituting an output page unit is large, or number of sets in output page unit is large.

Post-processing apparatus 300 executes post-processing on the image formed recording sheet. For example, the post-processing includes sorting process, punching process, stapling process, center folding process and cutting process.

### (Function of Image Forming Apparatus)

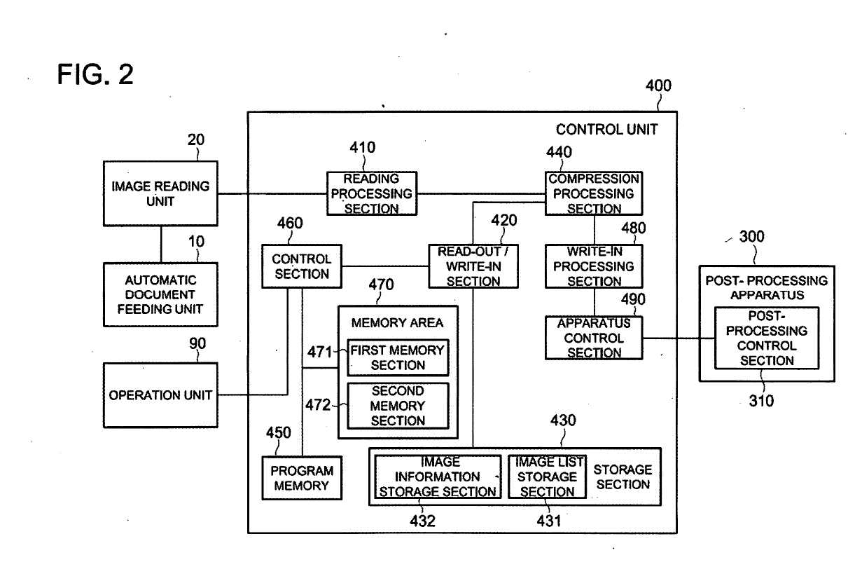

Referring to the drawings, functions of the image forming apparatus relating to the first embodiment will be described bellow. FIG. 2 is a block diagram showing image forming apparatus 100 relating to the first embodiment.

As shown in FIG. 2, image forming apparatus 100 has control unit 400 which comprehensively controls image forming apparatus 100. Control unit 400 includes reading processing section 410, read-out/write-in section 420, storage section 430, compression processing section 440, program memory 450, control section 460, memory area 470, write-in processing section 480, and apparatus control section 490.

Reading processing section 410 converts the analogue image data generated by image reading unit 20 into digital image data. Reading processing section 410 executes, for example, sampling processing, A/D conversion processing, and shading processing. Reading processing section outputs the digital image data to compression processing section 440.

Read-out/write-in section 420 is a memory controller such as a DRAM controller. Read-out/write-in section 420 writes-in the page data corresponding to each of the plurality of pages constituting the output page unit into storage section 430.

Meanwhile read-out/write-in section 420 reads-out the page data from storage section 430, when image forming unit 50 forms the image on the recording sheet. In cases where image forming apparatus 100 outputs an output page unit of a plurality of sets, read-out/write-in section 420 repeats the reading out for a number of times according to the output page unit of the plurality of sets.

Specifically, read-out/write-in section 420 writes-in an image list into image list storage section 431. Read-out/write-in section 420 reads-out an image list from image list storage section 431. Read-out/write-in section 420 writes-in the image data compressed by compression processing section 440 into image information storage section 432. Read-out/write-in section 420 reads-out the image data from image information storage section 432.

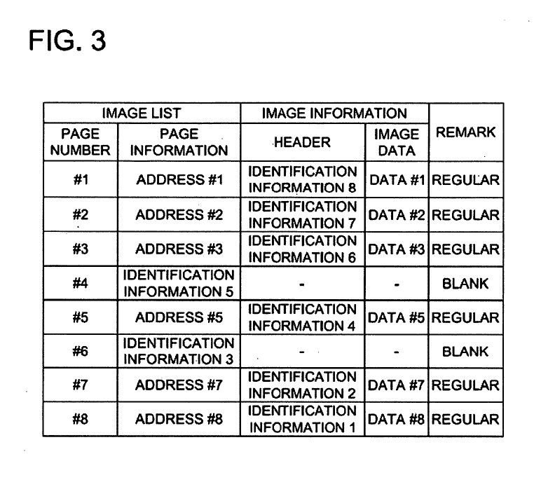

Here, the page data includes an image list and image information as shown in FIG. 3. The image list includes a page number and page information. The image information includes a header and a data main body. In the first embodiment a case is exemplified where an output page unit is configured with 8 pages. Since configuration of the page data differs according to whether the page is blank page or not, separately described are (1) the case where the page is not a blank page, namely the page is a normal page including an image, and (2) the case where the page is a blank page, not including an image.

(1) The case where the page is a normal page:

In this case, the image list includes a page number allocated to each page, and an address of the image data corresponding to each page. The address of the image data is the information indicating a position in image information storage section 432.

For example, with respect to page #1, the page number is #1, and the page information is “address #1” showing the position where “data #1” is stored in image information storage section 432.

The image information includes a header including identification information corresponding to each page, and image data. The identification information is such as a bit row allocated to each page. For example, the identification information is an identification code uniquely identifying the each page.

The identification code is for example allocated in ascending order or in descending order according to the page number. Specifically, the identification code is for example a code expressed with hexadecimal numbers. In case of the page being a normal page, the identification code is a code selected in descending order from the range of 0x00000001-0x7fffffff. In case of the page being a blank page, the identification code is a code selected in descending order from the range of 0x80000001-0xffffffff.

Meanwhile, the identification information is not necessarily an identification code uniquely identifying the each page. For example the identification information can be such as a number of pixels of the image data corresponding to each page, or a size of the image data corresponding to each page.

(2) The case where the page is a blank page:

In this case, the image list includes a page number allocated to each page, and page information including identification information corresponding to each page. As described above, the identification information is such as a bit row allocated to each page.

Here, in case of the page being a blank page, the image data is not necessary. Thus, image information including a header and an image data is not necessary. The page information needs not include the address of the image data.

Storage section 430 is for example configured with a DRAM. Storage section 430 includes image list storage section 431 and image information storage section 432. Image list storage section 431 is a memory area to store the above described image list. Image information storage section 432 is a memory area to store the above described image information.

Compression processing section 440 executes compression processing and decompression processing of digital image data. Specifically, compression processing section 440 executes compression processing of the digital data obtained from reading processing section 410, and obtains compressed image data. Compression processing section 440 outputs the image data to read-out/write-in section 420. Meanwhile, compression processing section 440 obtains the decompressed image data by decompressing the image data obtained from read-out/write-in section 420. The compression processing section 440 outputs the decompressed image data to write-in processing section 480.

Program memory 450 is configured with a nonvolatile memory such as a semiconductor memory. Program memory 450 stores a program to operate image forming apparatus 100.

Control section 460 operates based on the program stored in program memory 450. Specifically, control section 460 controls read-out/write-in section 420, compression processing section 440, and apparatus control section 490, etc., after expanding the program in memory area 470 described below.

Control section 460 executes calculation processing which depends on the reading-out order of the identification information for each output page unit, by the use of identification information included in the page data having been read out by reading processing section 410. Control section 460 temporarily stores the result of calculation in memory area 470.

As the calculation processing which depends on the reading-out order of the identification information, for example, CRC (Cyclic Redundancy Check) calculation processing can be utilized. In CRC calculation processing, control section 460 aligns a bit row configuring the identification information, according to the reading-out order. Subsequently, control section 460 divides the polynomial equation expressing the bit row with a generating polynomial equation. Control section 460 stores the residue obtained by dividing the polynomial equation with the generating polynomial equation into memory area 470 as the result of the calculation processing.

The calculation processing is not restricted to the CRC calculation processing. For example, as this calculation processing, other calculation processing using a hash function (such as MD; Message Digest) can be utilized. Namely this calculation processing is only required to be configured such that the result of the calculation processing is different if the aligned order of the bit row is different.

Control section 460 temporarily stores the result of calculation processing executed for output page unit of nth set (for example, output page unit of first set) into first memory section 471. Control section 460 temporarily stores the result of the calculation processing executed for the output page unit of other than nth set (for example, second or later set) into second memory section 472.

Control section 460 compares the result of calculation processing stored in first memory section 471 with the result of calculation processing stored in second memory section 472. Based on the result of comparison, control section 460 determines whether the reading-out process by red-out/write-in section 420 is correctly executed for the output other than nth set. Namely control section 460 executes abnormality determination processing for determining whether or not the images are correctly formed on the plurality of recording sheets in the output page unit other than the nth set.

Control section 460 determines that the images are correctly formed on the plurality of recording sheets in cases where the results of the calculation processing agree with each other. While, control section 460 determines that the images are not correctly formed on the plurality of recording sheets in cases where the results of the calculation processing disagree with each other.

As the cases where the images are not correctly formed on the plurality of recording sheets, can be considered are cases of such as a turnover of page orders or a missing page.

Control section 460 notifies a user of abnormality information indicating that images are not correctly formed, in cases where control section has determined that the images are not correctly formed on the plurality of recording sheets. For example control section 460 displays the abnormal information on a liquid crystal panel disposed on operation unit 90.

In cases where control section 460 determined that the images are not correctly formed on the plurality of recording sheets, it is preferable to specify a set number of the output page unit where the abnormality occurred. Control section 460 notifies the user on what order of set in output page unit the abnormality occurred. For example control section 460 displays the abnormal information indicating the abnormal set number on a liquid crystal panel disposed on operation unit 90.

Memory area 470 is a system memory to temporarily memorize various kinds of data such as a program data. Memory area 470 includes first memory section 471 and second memory section 472. As described above, first memory section memorizes the result of calculation processing executed for output page unit of nth set. Second memory section 472 memorizes the result of the calculation processing executed for the output page unit of other than nth set.

Write-in processing section 480 is the write-in processing section disposed on above described image reading unit 20. Specifically write-in processing section 480 generates an electrostatic latent image on the surface of the photosensitive drum based on the image data obtained from compression processing section 440.

Apparatus control section 490 totally controls the movement of image forming apparatus 100. For example, apparatus control section 490 executes such as a control of the roller group provided in paper feeding unit 40, a rotation control of the photosensitive drum provided in image forming unit 50, and a heating control of the heat roller provided in fixing unit 60.

### (Abnormality Determination Process)

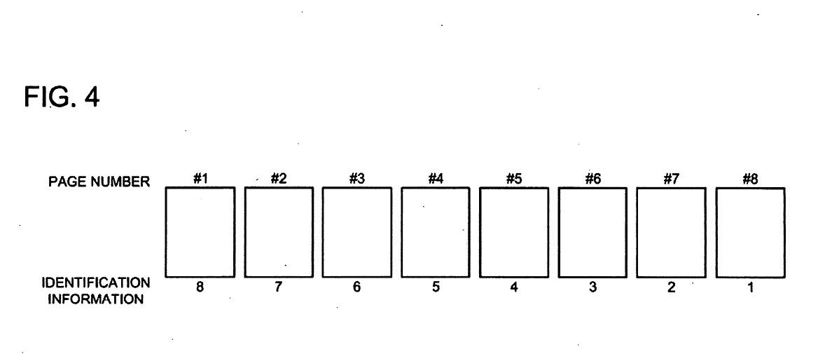

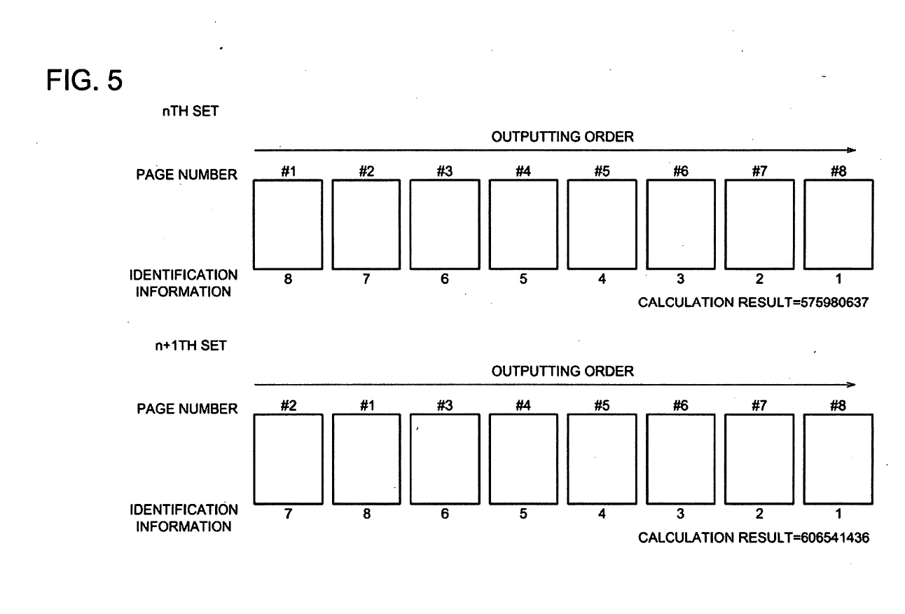

An example of abnormality determination process relating to the first embodiment will be described below referring to the drawings. FIGS. 4-5 are drawings showing the example of abnormality determination process relating to the first embodiment. Exemplified below is a case where the output page unit is configured with 8 pages.

AS shown in FIG. 4, a page number is allocated on each page, and identification information is correlated to each page. As described above, the identification information is such as a bit row allocated to each page.

As the timing to provide the identification information to each page, the following timings are applicable. At the time of converting the analogue image data to the digital image data, reading processing section 410 may provide the identification information to each page. At the time of compressing the digital image data, compression processing section 440 may provide the identification information to each page. And, at the time of storing the compressed image data into image information storage section 432 of storage section 430, read-out/write-in section 420 may provide the identification information to each page.

Namely, reading processing section 410, read-out/write-in section 420, or compression processing section 480 is configured to be a providing section to provide the identification information on each of the plurality of pages.

As for the identification information corresponding to a blank page, read-out/write-in section 420 may provide the identification information to each page when storing the image list into image list storage section 431 of storage section 430.

In the case shown in FIG. 5, in an output page unit of nth set, images are correctly formed on the plurality of recording sheets. While, in an output page unit of n+1th set, images are not correctly formed on the plurality of recording sheets. In the output page unit of n+1th set, page #1 and page #2 are replaced each other.

In this type of the case, above described control section 460 stores the result of calculation executed for the output page unit of nth set (in this case, “575980637”) into first storage section 471. Control section 460 stores the result of calculation executed for the output page unit of n+1th set (in this case, “606541436”) into second storage section 472.

Here, control section 460 executes calculation processing which depends on the reading-in order of the identification information. Accordingly, the result of calculation executed for the output page unit of n+1th set differs from the result of calculation executed for the output page unit of nth set. Thus, control section 460 determines that images are not correctly formed on the plurality of recording sheets.

### (Operation of Image Forming Apparatus)

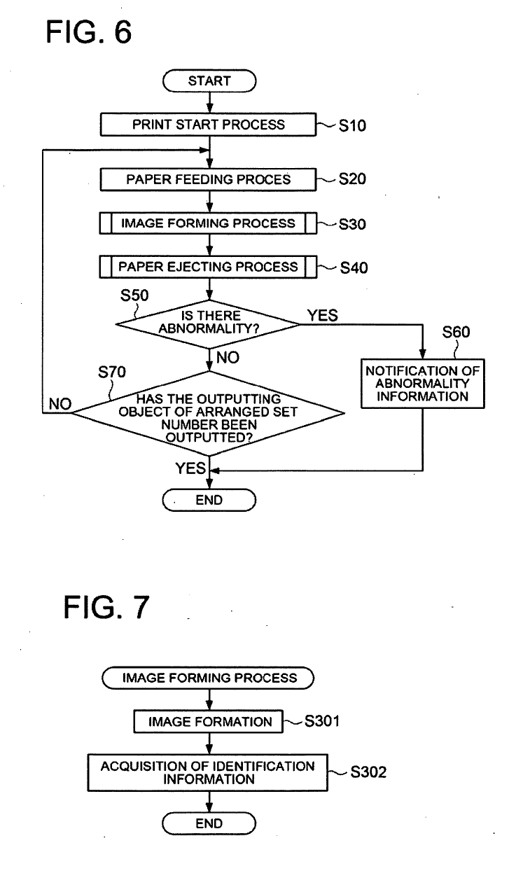

Operation of the image forming apparatus relating to the first embodiment will be described below referring to the drawings. FIGS. 6-8 are flow diagrams showing the operations of image forming apparatus relating to the first embodiment.

As shown in FIG. 6, in step S10, control section 460 starts print process to output images in an output page unit of arranged number of sets, wherein the output page unit of one set is configured with a plurality of pages.

In the process of step S20-step S40, images are formed on the plurality of recording sheets constituting the output page unit of one set. In the description below, the output page unit which being processed in the present flow is called as “output page unit of processing object”. The page being processed in the present flow is called as “processing object page”.

In step S20, control section 460 instructs apparatus control section 490 to execute paper feeding process to feed a recording sheet from paper tray unit 30 or paper supply apparatus 200.

In step S30, control section 460 executes the image formation process to form an image on a recording sheet. Details of the image formation process is described later (refer to FIG. 7).

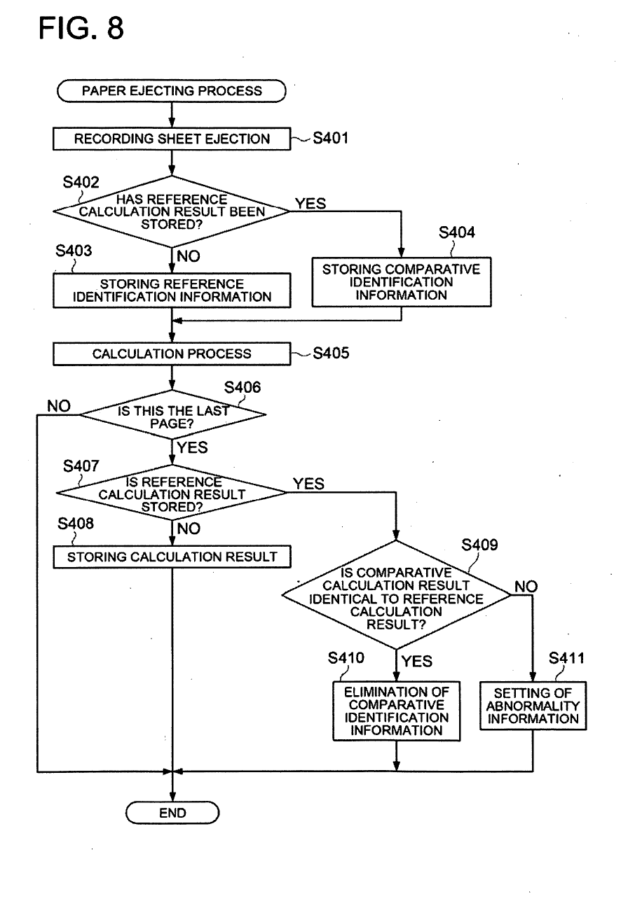

In step S40, control section 460 instructs for apparatus control section 490 to execute paper ejecting process to eject an image formed recording sheet. Details of the paper ejecting process is described later (refer to FIG. 8).

In step S50, control section 460 determines whether the images are correctly formed on the plurality of recording sheets. Here, control section 460 determines whether or not abnormality information is set. The abnormality information is set in step S411 which will be described later (refer to FIG. 8).

In step S60, control section 460 notifies the abnormality information to a user. For example, control section 460 displays the abnormality information on the liquid crystal panel provided on operation unit 90.

In step S70, control section 460 determines whether the output page unit of the arranged number of set has been outputted. Namely control unit 460 determines whether the plurality of recording sheets constituting the output page unit of the arranged number of set has been ejected. In the case where the output page unit of the arranged number of set is not yet outputted, the control section 460 returns to the process of step S20.

In the case where the output page unit of the arranged number of set is outputted, control section 460 finishes the print process to output the images of output page unit of plurality of sets.

Referring to FIG. 7, image forming process will be described below. As shown in FIG. 7, control section 460 forms an image on a recording sheet in step S301. Specifically, control section reads-out an image list from image list storage section 431 to obtain the page information of the processing object page.

In a case where the processing object page is a normal page, control section 460 reads-out the image information from image information storage section 432 to obtain the image data. Subsequently, control section 460 generates an electrostatic latent image on the surface of photosensitive drum based on the image data, after executing decompression processing of the image data. Control section 460 forms an image on a recording sheet by executing the fixing process etc.

Meanwhile, in a case where the processing object page is a blank page, control section 460 does not read-out the image information from image information storage section 432, but forms a blank paper page on the recording sheet.

In step S302, control section 460 obtains the identification information corresponding to the processing object page. In the case where the processing object page is a normal page, control section 460 obtains the identification information from the header included in the image information. While in the case where the processing object page is a blank page, control section 460 obtains the identification information from the page information included in the image list.

Referring FIG. 8, paper ejecting process will be described below. Here, the identification information read-out for the output page unit of a nth set will be called as “reference identification information”. The result of calculation processing executed for the output page unit of the nth set will be called “reference calculation result”. The identification information read-out for the output page unit of other than the nth set will be called as “comparative identification information”. The result of calculation processing executed for the output page unit of other than the nth set will be called “comparative calculation result”.

As shown in FIG. 8, in step S401, control section 460 instruct apparatus control section 490 to eject the image formed recording sheet.

In step S402, control section 460 determines whether the reference calculation result is stored. In the case where the reference calculation result is not stored, control section 460 moves to the process of step S403. While, in the case where the reference calculation result is stored, control section 460 moves to the process of step S404.

In step S403, control section 460 stores the reference identification information. In the case where the processing object page is a normal page, control section 460 stores the identification information included in the header of the image information as the reference identification information into memory area 470. While in the case where the processing object page is a blank page, control section 460 stores the identification information included in the page information of the image list as the reference identification information into memory area 470.

In step S404, control section 460 stores the comparative identification information. In the case where the processing object page is a normal page, control section 460 stores the identification information included in the header of the image information as the comparative identification information into memory area 470. While in the case where the processing object page is a blank page, control section 460 stores the identification information included in the page information of the image list as the comparative identification information into memory area 470.

In step S405, control section 460 executes the calculation processing which depends on the read-out order of the identification information (CRC calculation processing, for example).

In step S406, control section 460 determines whether the processing object page is the last page constituting the output page unit. In the case where the processing object page is the last page, control section 460 executes the process of step S407. While, in the case where the processing object page is not the last page, the present series of process is finished.

In step S407, control section 460 determines whether the reference calculation result is stored. In the case where the reference calculation result is not stored, control section 460 moves to the process of step S408. In the case where the reference calculation result is stored, control section 460 moves to the process of step S409.

In step S408, control section 460 stores the result of calculation processing executed for the output page unit of processing object as the reference calculation result into first memory section 471.

In step S409, control section 460 stores the result of calculation processing executed for the output page unit of processing object as the comparative calculation result into second memory section 472. Subsequently, control section 460 determines whether the comparative calculation result is identical to the reference calculation result. In the case where the comparative calculation result is identical to the reference calculation result, control section 460 moves to the process of step S410. Meanwhile, in the case where the comparative calculation result is not identical to the reference calculation result, control section 460 moves to the process of step S411.

In step S410, control section 460 deletes the comparative identification information from memory area 470. Further, control section 460 deletes the comparative calculation result from second memory section 472.

In step S410, control section 460 sets up abnormality information indicating that images are not correctly formed on the plurality of recording sheets constituting the output page unit of processing object. The abnormality information preferably includes the information indicating the set number of output page unit where the abnormality occurred.

### (Function and Effect)

According to the first embodiment, control section 460 executes the calculation processing, which depends on the reading-out order of page data, for each output page unit. And control section 460 determines whether images are correctly formed on a plurality of recording sheets based on the comparison of the results of calculation processing.

Here, it is noted that in cases where missing page or turnover of pages is occurred, the results of calculation processing are not identical with each other. Further, it is noted that the result of calculation processing is necessary to be managed only for each output page unit.

In this way, a page missing or a turnover of pages can be simply detected. Meanwhile, it is noted that in the first embodiment, attention is focused on a fact that the missing page or the turnover of pages is likely to be caused by the error at the time of reading-out the page data from storage section 430.

### Second Embodiment

Referring to the drawings, the second embodiment will be described below. In the following description, different points between the first embodiment and the second embodiment are mainly explained.

Regarding the first embodiment, the case where image forming apparatus is a copying machine is specifically explained. Meanwhile, in the second embodiment, another case will be described as an example where image forming apparatus is an MFP (Multi Function Peripheral) having a copying function and a printing function.

### (Function of Image Forming Apparatus)

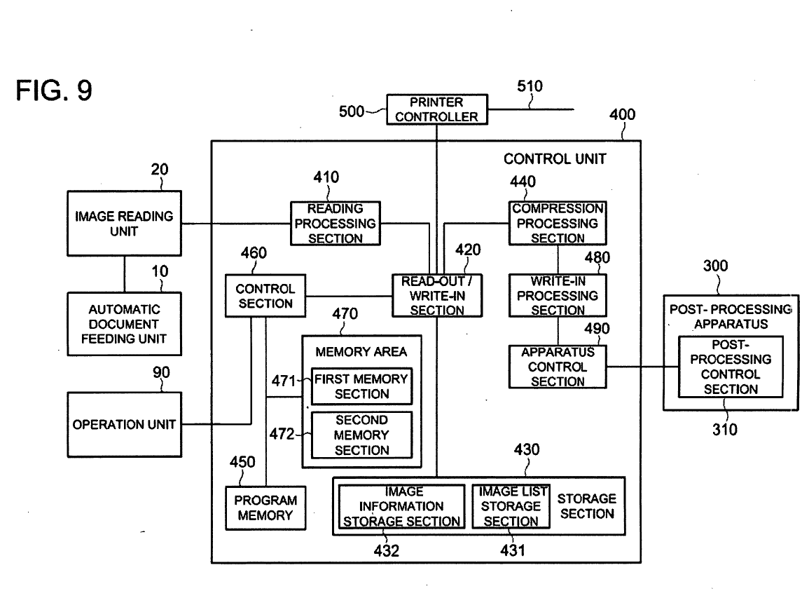

Referring the drawings, functions of the image forming apparatus relating to the second embodiment will be described below. FIG. 9 is a block diagram showing configurations of image forming apparatus 100 relating to the second embodiment. In FIG. 9, a same sign is attached to the same part as that of FIG. 1.

As shown in FIG. 9, printer controller 500 is connected to control unit 400. Printer controller 500 is connected to an external apparatus such as a personal computer (not illustrated) through line 510. Line 510 can be for example a wired LAN or a wireless LAN.

Printer controller 500 obtains image data constituting an output page unit from the external apparatus. Printer controller may obtain compressed image data or image data before compression. Further, printer controller 500 may obtain blank page indicating information to indicate a blank page from the external apparatus.

Printer controller 500 may obtain the image data on which identification information is already provided. Similarly, printer controller 500 may obtain the blank page indicating information on which identification information is already provided.

In cases where identification information is not previously provided, printer controller 500 may provide identification information on each page. Further, similarly to the first embodiment, the identification information may be provided on each page by reading processing section 410, read-out/write-in section 420, or compression processing section 440.

### The Other Embodiment

The present invention has been described by taking the above-described embodiments, however, the descriptions and drawings constituting a part of the disclosure should not be construed to limit the present invention. From the present disclosure, those skilled in the art will be possible to develop various kinds of substitute embodiments, examples and employing technologies.

For example, image forming apparatus 100 can be an apparatus having only the printer function, not a coping machine or an MFP.

Although not mentioned in the above-described embodiments, the blank page can be specified through operation unit 90.

In the above-described second embodiment, printer controller 500 is provided separately from control unit 400. However, printer controller 500 can be installed in control unit 400.

According to the present invention, an image forming apparatus, which can easily detect a page missing and a turned-over pages, can be provided.

What is claimed is:

1. An image forming apparatus for outputting images in an output page unit of a plurality of sets, wherein the output page unit of one set is configured with a plurality of pages, each page having a specified order; the image forming apparatus comprising:
a storage section which stores page data corresponding to each of the plurality of pages, the page data including identification information corresponding to each of the plurality of pages;
a reading-out section which reads out the page data from the storage section according to the output page unit of the plurality of sets;
an image forming section which, based on the page data read out by the reading-out section, sequentially forms each of the images corresponding to each of the plurality of pages on a plurality of recording sheets;
a control section which executes a calculation processing that depends on the read out order of the page data, for each of the output page unit, by using the identification information included in the page data read out by the reading-out section;
a first memory section which memorizes a first result of the calculation processing executed for the output page unit of a nth set out of the output page unit of the plurality of sets; and
a second memory section which memorizes a second result of the calculation processing executed for the output page unit of other than the nth set out of the output page unit of the plurality of sets;
wherein the control section comprises a determination section which determines whether the images are correctly formed on the plurality of recording sheets for the output page unit of other than the nth set, based on a result of comparison of the first result of calculation processing memorized in the first memory section with the second result of calculation processing memorized in the second memory section.

2. The image forming apparatus of claim 1, further comprising:
a compression section which compresses image data corresponding to each of the plurality of pages to obtain compressed image data; and
a providing section which provides the identification information on each of the plurality of pages, wherein the storage section stores the identification information and the compressed image data as the page data.

3. The image forming apparatus of claim 1, further comprising:
a notifying section which notifies that an abnormality has occurred, in a case where the determination section has determined that the images are not correctly formed on the plurality of recording sheets.

4. The image forming apparatus of claim 3, wherein the notifying section notifies a set number of the output page unit where an abnormality has occurred, in the case where the determination section has determined that the images are not correctly formed on the plurality of recording sheets.

5. The image forming apparatus of claim 1, wherein the calculation processing that depends on the read out order of the page data is CRC (Cyclic Redundancy Check) calculation processing.

6. An image forming method for outputting images in an output page unit of a plurality of sets, wherein the output page unit of one set is configured with a plurality of pages, each page having a specified order; the image forming method comprising:
storing page data corresponding to each of the plurality of pages, the page data including identification information corresponding to each of the plurality of pages;
reading-out the stored page data according to the output page unit of the plurality of sets;
sequentially forming each of the images corresponding to each of the plurality of pages on a plurality of recording sheets, based on the read-out page data;
executing a calculation processing that depends on the read-out order of the page data, for each of the output page unit, by using the identification information included in the page data read out by the reading-out section;
memorizing a first result of the calculation processing executed for the output page unit of a nth set out of the output page unit of the plurality of sets;
memorizing a second result of the calculation processing executed for the output page unit of other than the nth set out of the output page unit of the plurality of sets; and
determining whether the images are correctly formed on the plurality of recording sheets for the output page unit of other than the nth set, based on a result of comparison of the first result of calculation processing memorized in the first memory section with the second result of calculation processing memorized in the second memory section.

7. The image forming method of claim 6, further comprising the steps of:
compressing image data corresponding to each of the plurality of pages to obtain compressed image data; and
providing the identification information on each of the plurality of pages; and
storing the identification information and the compressed image data as the page data.

8. The image forming method of claim 6, further comprising the step of:
notifying that an abnormality has occurred, in a case where determined is that the images are not correctly formed on the plurality of recording sheets.

9. The image forming method of claim 8, wherein in the notifying step, a set number of the output page unit where an abnormality has occurred is notified, in the case where determined is that the images are not correctly formed on the plurality of recording sheets.

10. The image forming method of claim 6, wherein the calculation processing that depends on the read out order of the page data is CRC (Cyclic Redundancy Check) calculation processing.
